(19) United States
(12) Patent Application Publication
(10) Pub. No.: US 2007/0212452 A1
(43) Pub. Date: Sep. 13, 2007

(54) Food Additives, Foods and Methods of Making Foods

(76) Inventor: Brian John Franklin, Neston (GB)

Correspondence Address: Robert C Klinger;Jackson Walker, Suite 6000, 901 Main Street, Dallas, TX, 75202, US

(21) Appl. No.: 10/582,284

(22) PCT Filed: Jun. 30, 2004
(86) PCT No.: PCT/GB04/02795

§ 371 Date: Apr. 23, 2007

(30) Foreign Application Priority Data
Dec. 12, 2003 (GB) PCT/GB03/05429

(51) Int. Cl. A21D 13/00

(52) U.S. Cl. 426/94

(57) ABSTRACT

The invention provides a method of preparing a processed food for heating or cooking in a microwave oven, the method comprising including in the food a suitable amount of a bean powder selected from the group consisting of lima bean powder and deodorised bean powders. The invention also provides a food additive composition comprising a bean powder selected from the group consisting of lima bean powder and deodorised bean powders, and at least one further component selected from the group consisting of a water absorbent vegetable fibre, an inorganic calcium compound and a modified cellulose.

The present invention relates to food additives for adding to processed foods. For example, dough based foods to be baked or fried and subsequently heated or cooked in a microwave oven. The invention relates to food products and to ingredients for food products, including foods comprising a core and a coating surrounding the core, for example a battered or breaded product. The invention also relates to foods or ingredients containing the food additives and to methods of improving the texture and characteristics of foods heated in a microwave oven.

Microwave ovens possess the ability to heat, cook or bake items, particularly foodstuffs, extremely rapidly. Unfortunately, microwave heating also has its disadvantages. For example, microwave heating alone often fails to achieve such desirable results as evenness, uniformity, browning, crispening, and reproducibility.

Processed baked or fried food products cooked or heated in a microwave oven seldom retain the characteristics of the same food cooked or heated in a convection oven. This is particularly so if the food product has been frozen or chilled.

Whereas in conventional cooking heat is applied from the outside, in microwave cooking heat is generated from beneath the surface of the food product and the process can be very rapid and quite violent. A consequence of this is to rapidly convert some of the available water to steam during the microwave cycle. After heating the foodstuff “rests” during which period there is a release of water which can drip from the product. This is particularly noticeable for example when heating frozen food, especially that with a coating such as breadcrumb or including pastry, which foods can become soggy and unpalatable.

Attempts have been made to limit the escape of moisture during microwave cooking by coating the product with a composition adapted to form an impermeable film. These attempts have been unsatisfactory because the natural distribution of water within the coated product can be lost. Furthermore an impenetrable coating or film detracts from the taste and mouth feel of the product.

Accordingly, there remains a desire for foods which, on microwave cooking, reheating or defrosting have characteristics more similar to foods cooked, reheated or defrosted in a conventional manner.

In international patent application No PCT/GB2003/005429 claiming priority from British patent application No 0229413.0, food additives for use in microwavable foods are disclosed comprising bean powder (principally lima bean powder), water absorbent vegetable fibre, one or more inorganic calcium compounds and modified cellulose. Surprisingly, the inventor has found that the bean powder is the key ingredient, that is, a significant improvement in foods can be achieved using only the be an powder although the water absorbent vegetable fibre, the calcium compound or compounds and the modified cellulose each provides its own additional benefits.

Accordingly, the invention provides a method of preparing a processed food for heating or cooking in a microwave oven, the method comprising including in the food a suitable amount of a bean powder selected from the group consisting of lima bean powder and deodorised bean powders.

The invention also provides a food additive composition comprising a bean powder selected from the group consisting of lima bean powder and deodorised bean powders, and at least one further component selected from the group consisting of water absorbent vegetable fibres, inorganic calcium compounds and modified celluloses.

The food additive may also include other components, for example, added maltodextrins, proteins, herbs, spices or seasonings. Preferably, those other components will be present at less than 90%, more preferably less than 50% by weight based on the total weight of the food additive. The food additive, when added during the preparation of processed foods, allows such foods heated or cooked using a microwave oven to have properties more similar to the same such food when heated or cooked using a convection oven.

The present invention therefore provides a food additive composition which is capable of retaining to a significant extent the characteristics of a baked or fried food to which it has been added and that has been cooled and subsequently heated in a microwave oven.

Preferably, the bean powder is included in the food in an amount of from 0.1 to 20%, more preferably from 0.1 to 10%, advantageously from 0.1 to 5% by weight based on the total weight the food.

The bean powder component of the method and food additive composition of the present invention is preferably derived from the lima pulse. Lima bean powder is particularly preferred because of its bland taste and colour and also because it is a good source of soluble dietary fibre of a sticky or gum-like character, with bonding and moisture retaining properties. It provides fat, which is capable of absorbing carbohydrate, and protein which is able to form a complex matrix of organic linkages with the other constituents of the additive and the food to which it is added, thereby helping to retain the structure of the food during microwave heating.

The term ‘deodorised bean powder’ as used herein refers to other pulses such as broad, soya, haricot, mung, kidney, etc beans and chickpeas which in the natural form have too strong flavours or colours to be suitable for use in the food additive ingredient of the present invention, but which have been rendered suitable by chemical, genetic or enzymatic processing.

The bean powder preferably has a sieve analysis of 90% or over (preferably about 98%) through a 140 micrometer sieve.

Lima bean powder may be obtained from Arcadia Foods of Bradford, UK. Generally, the composition of lima powder comprises 11.6% moisture, 46.2% starch of which 3.6% is sugars, 19.1% is protein, 1.2% is fat and 21.5% is dietary fibre. Seasonal variations of up to 5% may occur.

As mentioned above, it is not necessary to use the bean powder in combination with other ingredients in the method of the invention. However, further improvements in food texture may be obtained by also adding water absorbent vegetable fibre, an inorganic calcium compound and/or modified cellulose to the food.

In the method of the invention the bean powder may be added to the rest of the food in the form of a composition comprising the bean powder and at least one other component. Optionally the bean powder is added in the form of a food additive composition comprising more than 90% by weight of the bean powder.

The water absorbent vegetable fibre is a vegetable fibre which is capable of absorbing at least its own weight in water, for example, potato fibre. Preferably, the water absorbent fibre can absorb at least two, more preferably at least five times its own weight in water. The water absorbent vegetable fibre is preferably added to the food or is present in the food additive composition at from 1 to 50%, more preferably from 2 to 30% by weight based on the weight of the bean powder.

Potato fibre is a natural product which is derived from potatoes. Potato fibre provides the food additive with moisture absorbing properties as it is capable of absorbing up to 10 times its weight in moisture. It provides a drying function and is described as locking moisture.

Preferably, the potato fibre is a fine powder of fibre with a sieve analysis of 85% or over (preferably about 90%) through a 250 micrometer sieve.

Potato fibre powder suitable for use in the composition of the present invention may be obtained from Avebe of the Netherlands. Generally, the composition of potato fibre powder comprises 70-75% dietary fibre, 250 mg/g starch, 5% protein, 2% ash, 10 mg/kg sulphite and 50 mg/g moisture.

When used, the inorganic calcium compound is preferably added to the food or is present in the additive composition at from 1 to 50%, preferably from 2 to 30% by weight based on the total weight of the bean powder. The inorganic calcium compound may be a calcium salt or mineral. The inorganic calcium compound is preferably calcium carbonate. The calcium carbonate component may be crystalline calcium carbonate, preferably BM grade which is produced in the United Kingdom and may be obtained from Food Ingredient Technology Limited of Bedfordshire, UK.

The modified cellulose component which may be added to the food or used in the food additive composition of the present invention is, for example, a natural product produced from vegetation and wood pulps as a free-flowing powder and may be obtained from Food Ingredient Technology Limited of Bedfordshire, UK. If used, the modified cellulose should be at least partly soluble in water and is preferably completely soluble in water.

Modified cellulose is believed to complex with starch elements providing a contribution to the organic linkages between the constituents of the food additive and the food to which it is added. It also provides fat and moisture holding properties.

When used, the modified cellulose is preferably present at from 1 to 50%, more preferably from 2 to 30%, most preferably from 2 to 20% by weight based on the weight of the bean powder.

The modified cellulose is preferably LIG 55 Methocel A4M food grade modified cellulose.

The method may also involve addition of, or the food additive composition may further comprise, one or more added dextrins (some dextrin may also be present as a constituent of the bean powder). The addition of dextrins provides a further firming enhancer for particular circumstances and can also enhance the crispiness of a coating comprising the composition, for example, a coating on a meat product. Where dextrin is present it is preferably in an amount of no more than 100% by weight based on the weight of the bean powder.

Optionally, the method also involves addition of or the composition also contains added non-gluten forming protein (apart from any protein present in the bean powder or vegetable fibre). Where present, the non-gluten forming protein will preferably be in an amount of not more than 100% by weight based on the weight of the bean powder.

The food additive is particularly suitable for use with foods derived from cereals or pulses which are processed, baked or fried and then reheated or cooked. Optionally the food may be frozen or chilled prior to reheating or cooking.

The method and the food additive of the present invention may be used for all savoury and sweet processed foods, especially dough based foods and batters (both fermented and non-fermented), inclusive of potato doughs. The food additive may also be used for fillings, toppings, coatings or dustings of dough based foods, batters and potato doughs, including dry crumb coatings and the dusting of such doughs at specific processing steps.

As used herein, the expression “processed food” refers to food or a food component which has been processed in any way, for example, by milling, grinding, cooking or combining with other ingredients. Thus, raw uncut vegetables and unmilled cereals are not processed foods. Wheat flour, for example, is a processed food because it is produced by processing (milling) wheat.

A non-exhaustive and non-limiting list of processed foods which benefit from the use of the method and food additive according to the present invention includes pasta, puff pastry products such as pies, rolls and slices with both sweet and savoury fillings or toppings, bread, especially crusty bread products such as baguettes, loaves and rolls (including fillings), garlic bread, soft bread products such as fruited buns, hot dog rolls, burger buns, baps and naan bread, pita bread, tortilla wraps and pizzas, both pizza bases or topped pizzas, batters for Yorkshire pudding, choux buns, various nuggets, fritters, crumpets, batters for cakes such as sponge cakes, and puddings, potato products such as roast potatoes, French fries, potato wedges waffles, potato croquettes and shaped potato products, baked or fried filo pastries such as spring rolls, samosas, parcels, morning goods including croissants, Danish pastries, doughnuts, including filled and topped doughnuts, shortcrust pastries, including pies and crumbles (with both sweet and savoury fillings), and bread crumb for coating for example for coating fish or meat, for example, chicken pieces or products, including shaped fish or chicken products such as fingers or nuggets.

The food additive composition of the present invention is advantageously included in the processed food in an amount of from 0.1 to 15%, preferably 0.1 to 10%, more preferably 0.1 to 5% by weight based on the total weight of the processed food and the food additive composition.

The bean powder or food additive composition may be added to base dough formulations at 0.5% to 5.0% (based on the weight of flour), to base batter formulations at 0.75% to 8.5% (based on the weight of flour), to base potato dough formulations at 0.5% to 3.0% (based on the weight of potato), to fillings/toppings at 1.0% to 5.0% (based on the weight of dry ingredients), or to subsequent dough processing steps at 0.1% to 1.5% (based on the weight of dry ingredients). Preferably, the above produce systems are baked or fried, then cooled frozen and packaged.

Except for the addition of the bean powder or food additive composition as described above, the cooking (baking or frying) process may be otherwise conventional. The finished food thus produced is particularly suitable for the preparation of microwave heatable foods. To this end, the finished fast food may be wrapped with a microwave heatable packaging material and then stored or shipped in refrigerated or frozen storage for heating in microwave heater at home or in restaurants or shops or automated vending machines having a self-contained microwave heater to an optimum temperature without damaging the quality of food.

Alternatively, the food may be shipped as a frozen semi-finished product. Final cooking of this semi-finished product may conveniently be completed at home or in restaurants (including fast-food restaurants) or bakeries (including in-store bakeries) or shops, etc.

The packaging materials for wrapping finished fast food or semi-finished foods according to this invention must withstand or be adapted for microwave heating. Plastic laminates adapted for microwave heating are preferable for packaging the products to be sold by automated vending machines having a self-contained microwave heater in particular since the products are rapidly heated from frozen state to an elevated temperature.

The foods may be packaged in packaging utilising susceptor technology, that is using a device which, when disposed in a microwave energy field such as exists in a microwave oven, responds by generating a significant amount of heat. The susceptor absorbs a portion of the microwave energy and converts it directly to thermal energy which is useful for example to crispen or brown foodstuffs.

The absorption of microwave energy by the susceptor device reduces the amount of microwave energy available to cook the food. Simultaneously, the susceptor makes thermal energy available for surface cooking of the food by conductive or radiant heat transfer. Thus, susceptors tend to slow down direct microwave induction heating to provide some thermal heating which tends to be more uniform and provide such desirable results as browning or crispening.

Currently, the most commercially successful microwave susceptor is a thin film susceptor. Typically, thin film susceptors are formed of a thin film of metalised aluminium vacuum deposited on a polyester layer which is adhered to paper or cardboard.

Susceptors have been described in U.S. Pat. No. 4,640,838 issued to Isakson et al., U.S. Pat. No. 4,518,651 to Wolfe, Jr., and U.S. Pat. No. 4,959,516 issued to Tighe et al. Each of these susceptors and improvements thereto are suitable for use in packaging foods containing the food additive composition according to the present invention.

In one embodiment of the method of the invention, where the bean powder is added with water absorbent vegetable fibre, one or more inorganic calcium compounds and modified cellulose, the bean powder is present in a proportion of less than 50% or more than 90% by weight based on the total weight of the bean powder, the water absorbent vegetable fibre, the one or more inorganic calcium compounds and the modified cellulose.

Optionally, the method is one in which a food additive composition comprising:
i) bean powder;
ii) water absorbent vegetable fibre (optionally at from 3 to 12% by weight based on the total weight of i), ii), iii) and iv));
iii) one or more inorganic calcium compounds (optionally at from 2 to 10% by weight, based on the total weight of i), ii), iii) and iv)); and
iv) modified cellulose (optionally at between 0.5 and 10% by weight based on the total weight of i), ii), iii) and iv)),

wherein i) is present in an amount of between 50 to 90% (optionally 60 to 90%) by weight based on the total weight of the bean powder; is not included in the food.

Optionally, the method is one in which a food additive composition comprising 80-90% bean powder, 5-7% fine potato fibre, 3-5% calcium carbonate and 1-4% modified cellulose as active ingredients, is not added to the food.

Optionally, the method is one in which a food additive composition obtainable by:

a) mixing 2000 grams lima powder with 140 grams potato fibre material with 100 grams of modified cellulose and 100 grams of calcium carbonate at 25 degrees centigrade and atmospheric pressure in a Hobart blender for 5 minutes; or by

b) mixing 300 kg of lima powder, 22 Kg potato fibre, 17.5 Kg calcium carbonate and 17.5 Kg modified cellulose in a Gardner blender at 25 degrees centigrade and atmospheric pressure for 5 minutes to produce a homogeneous mixture; is not added to the food.

In a further embodiment, if the food additive composition comprises bean powder, water absorbent vegetable fibre, one or more inorganic calcium compounds and modified cellulose, then the bean powder is present in a proportion of less than 50% or more than 90% by weight based on the total weight of the bean powder, the water absorbent vegetable fibre, the one or more inorganic calcium compounds and the modified cellulose.

Optionally, the food additive composition is not a composition comprising:
i) bean powder;
ii) water absorbent vegetable fibre (optionally at from 3 to 12% by weight based on the total weight of i), ii), iii) and iv));
iii) one or more inorganic calcium compounds (optionally at from 2 to 10% by weight based on the total weight of i), ii), iii) and iv)); and
iv) modified cellulose (optionally at between 0.5 and 10% by weight based on the total weight of i), ii), iii) and iv)),

wherein i) is present in an amount of between 50 to 90% (optionally 60 to 90%) by weight based on the total weight of the bean powder.

Optionally, the food additive composition is not one comprising 80-90% bean powder, 5-7% fine potato fibre, 3-5% calcium carbonate and 1-4% modified cellulose as active ingredients.

Optionally, the food additive composition is not one obtainable by

a) mixing 2000 grams lima powder with 140 grams potato fibre with 100 grams of modified cellulose and 100 grams of calcium carbonate at 25 degrees centigrade and atmospheric pressure in a Hobart blender for 5 minutes; or by

b) mixing 300 kg of lima powder, 22 Kg potato fibre, 17.5 Kg calcium carbonate and 17.5 Kg modified cellulose in a Gardner blender at 25 degrees centigrade and atmospheric pressure for 5 minutes to produce a homogeneous mixture.

Examples of the method and food additive composition of the invention are described below for the purpose of illustration only.

### EXAMPLE 1—Puff Pastry Products

A puff pastry dough would be prepared to the following recipe:

| | | |
|---|---|---|
| Strong Flour | 80 | Kg |
| Pastry Fat | 3 | Kg |
| Salt | 0.5 | Kg |
| Cream of Tartar | 0.1 | Kg |
| Lima Bean Powder | 0.8 | Kg |
| Water | 50 | Litres |

The ingredients would be mixed to a firm smooth dough cut to 9 Kg pieces, folded and rested as is conventional for puff pastry. The pastry would then be combined with the desired filling, baked as appropriate and frozen. Upon microwave reheating the product would show improved texture and mouthfeel as compared to a similar product made without the lima bean powder.

### EXAMPLE 2—Crusty Breads

A crusty bread would be prepared to the following recipe:

| | | |
|---|---|---|
| Strong Flour | 180 | Kg |
| Vegetable oil | 7.2 | Kg (olive oil for garlic bread) |
| Salt | 1.69 | Kg |
| Lima Bean Powder | 2.0 | Kg |
| Potato Fibre | 0.2 | Kg |
| Yeast | 3.0 | Kg |
| Improver | 1.0 | Kg for baguettes only |
| Garlic Granules | 1.125 | Kg for garlic bread only |
| Water | 115 | Litres |

The ingredients would be mixed to give the dough. The dough would be cut into pieces, shaped and dusted with lima powder. After 1 hour fermentation the pieces would be baked and then frozen. On defrosting in a microwave oven, the bread would show an improved texture as compared to a defrosted bread not having the bean powder and potato fibre.

### EXAMPLE 3—Bread Crumb for Coating Meat and Fish Products

A bread crumb would be prepared to the following recipe:

| | | |
|---|---|---|
| Bread Flour | 15.000 | Kg |
| Lima Bean Powder | 3.400 | Kg |
| Potato Fibre | 0.200 | Kg |
| Calcium Carbonate | 0.200 | Kg |
| Vegetable fat | 3.000 | Kg |
| Yeast | 0.400 | Kg |
| Salt | 1.400 | Kg |
| Sugar | 0.700 | Kg |
| Water | 9.500 | Litres |

The dough would be mixed, cut into pieces and baked. The loaves would then be shredded and dusted with lima bean powder.

### EXAMPLE 4—High Protein Foods and Products Comprising Vegetables, such as Meat Pies

Method i)

The product, for example a pork cutlet or a carrot finger, would be coated with 1.5 to 5% by weight based on the weight of the product of a 60:30:10 mixture of lima bean powder, potato fibre and modified cellulose, to give a coated product.

Method ii)

The product would be treated according to method i) and would then be coated with 20% to 30% by weight of batter based on the weight of the product to give a coated, battered product.

Method iii)

The product would be treated according to method ii) and would then be coated with 17.5 to 27.5% crumbs by weight based on the weight of the product to give a coated, battered and crumbed product.

If desired, the coating applied in method i) may include non-active ingredients to provide flavour. For example, where a savoury product is desired, the coating may be a savoury coating including seasoning or spices.

1-43. (canceled)

44. A method of preparing a processed food for heating or cooking in a microwave oven, the method comprising including in the food an effective amount of a bean powder selected from the group consisting of lima bean powder and deodorised bean powders.

45. A method as claimed in claim 44 in which the processed food comprises a coating or batter and the bean powder is included in that coating or batter or in which the processed food comprises pastry and the bean powder is included in that pastry.

46. A method as claimed in claim 44 in which the method of preparing the food involves preparing a dough and the bean powder is included in that dough or in which the bean powder is dusted onto the exterior surface of the food, or in which the food is prepared and is then chilled or frozen.

47. A method according to claim 46 in which the food is prepared and then baked or fried prior to being chilled or frozen.

48. A method as claimed in claim 44 in which the food is a processed food selected from the group consisting of puff pastry products, pasta, pies, rolls and slices with both sweet and savoury fillings or toppings, bread, including crusty bread products, baguettes, loaves and rolls, garlic bread, soft bread products, fruited buns, hot dog rolls, burger buns, baps and naan bread, pita bread, tortilla wraps and pizzas, pizza bases, topped pizzas, batters for Yorkshire pudding, choux buns, nuggets, fritters, crumpets, cakes, sponge cakes, puddings, potato products, roast potatoes, French fries, potato wedges waffles, potato croquettes and shaped potato products, baked or fried filo pastries, spring rolls, samosas, parcels, morning goods including croissants, Danish pastries, doughnuts, shortcrust pastries, including pies and crumbles (with both sweet and savoury fillings), bread crumb for coating, and crumb coated meat, fish or poultry pieces or products, including shaped meat, fish or poultry products such as fingers or nuggets.

49. A method as claimed in claim 44 in which the bean powder is included in a proportion of from 0.15 to 10% by weight based on the total weight of the food.

50. A method as claimed in claim 44 in which a water absorbent vegetable fibre is included with the bean powder, wherein the water absorbent vegetable potato fibre which is included at from 1 to 50% by weight based on the weight of the bean powder.

51. A method as claimed in claim 44 in which one or more inorganic calcium compounds are included with the bean powder, wherein the inorganic calcium compound is calcium carbonate which is included at from 1 to 50% by weight based on the weight of the bean powder.

52. A method as claimed in claim 44 in which a modified cellulose is included with the bean powder, wherein the modified cellulose is included at between 1 and 50% by weight based on the weight of the bean powder.

53. A method as claimed in claim 44 in which water absorbent vegetable fibre, one or more inorganic calcium compounds and modified cellulose are included with the bean powder.

54. A food additive composition comprising a bean powder selected from the group consisting of lima bean powder and deodorised bean powders, and at least one further component selected from the group consisting of a water absorbent vegetable fibre, an inorganic calcium compound and modified cellulose.

55. A food additive composition according to claim 54 which comprises water absorbent vegetable fibre, in which the water absorbent vegetable fibre is potato fibre and the potato fibre is present in an amount of 1 to 50% by weight based on the weight of the bean powder.

56. A food additive composition as claimed in claim 54 which comprises an inorganic calcium compound, wherein the inorganic calcium compound is calcium carbonate and wherein the calcium carbonate is present in an amount of 1 to 50% by weight based on the weight of the bean powder.

57. A food additive composition as claimed in claim 54 which comprises modified cellulose, in which the modified cellulose is present at from 1 to 50% by weight based on the weight of the bean powder.

58. A processed food comprising a food additive composition comprising a bean powder selected from the group consisting of lima bean powder and deodorised bean powders, and at least one further component selected from the group consisting of a water absorbent vegetable fibre, an inorganic calcium compound and modified cellulose.

59. A processed food as claimed in claim 58 packaged in a microwave heatable packaging material.

60. A processed food as claimed in claim 59 in which the packaging utilises susceptor technology.

61. A processed food as claimed in claims 58 which comprises the bean powder or the food additive composition as a dusting or coating.

62. A processed food according to claim 58 wherein the processed food is selected from the list consisting of a base dough formulation comprising the food additive composition in an amount of 0.5 to 5.0% based on the total weight of the dough, a base batter formulation comprising the food additive composition in an amount of from 0.75 to 8.5% based on the total weight of the dough, a base potato dough formulation comprising the food additive composition in an amount of from 0.5% to 3.0% by weight based on the total weight of the dough and a filling or topping for a dough product comprising the food additive composition in an amount of from 1.0% to 5.0% by weight based on the total weight of the filling or topping.
